(19) United States
(12) Patent Application Publication
(10) Pub. No.: US 2014/0136242 A1
(43) Pub. Date: May 15, 2014

(54) HOME SENSOR DATA GATHERING FOR INSURANCE RATING PURPOSES

(71) Applicant: STATE FARM MUTUAL AUTOMOBILE INSURANCE COMPANY, (US)

(72) Inventors: Jack Weekes, Bloomington, IL (US); Andrew Reeser, Heyworth, IL (US); Shawn M. Call, Bloomington, IL (US); Stacy L. Kennedy, Bloomington, IL (US); Lisa Ann Frey, Normal, IL (US); Kevin Payne, Lexington, IL (US); Michael Jacob, Le Roy, IL (US)

(73) Assignee: STATE FARM MUTUAL AUTOMOBILE INSURANCE COMPANY, Bloomington, IL (US)

(21) Appl. No.: 13/674,582

(22) Filed: Nov. 12, 2012

(51) Int. Cl. G06Q 40/08

(52) U.S. Cl. 705/4

(57) ABSTRACT

In a computer-implemented method of incentivizing low-loss behaviors, in-home data is received. The in-home data is generated by, or based on information generated by, a device located at a residence of an individual, and is indicative of one or both of (i) a utilization of the device and (ii) a condition monitored by the device. The method also includes determining, based on the received in-home data, an insurance premium adjustment for the individual, and providing an indication of the determined insurance premium adjustment.

### TECHNICAL FIELD

The present application relates generally to insurance and, more specifically, to systems and methods for collecting and processing data for insurance rating purposes.

### BACKGROUND

In insurance industries, such as property/casualty, liability, life, and health insurance industries, insurance providers generally seek to determine an insurance policy premium that is appropriate given the risk of losses (e.g., property theft, property damage, health issues requiring medical treatment, death, etc.) for the individual owning the policy. For purposes of making this determination, it is well understood that behaviors of an individual can exert a great influence on the probability that the individual experiences a loss that is recognizable under the policy. For example, an individual who smokes cigarettes on a regular basis is much more likely to incur large medical bills as compared to a non-smoker. In some circumstances, behaviors such as this must be learned based on information provided by the insurance policy holder, or future insurance policy holder, in response to questions from the insurer (e.g., questions regarding how much the individual smokes cigarettes, drinks alcoholic beverages, etc.). Generally, individuals demonstrating behaviors corresponding to a lower risk of loss (“low-loss behaviors”) may be assigned a more positive rating, and may therefore be offered lower premiums for a given level of coverage. Conversely, individuals demonstrating behaviors corresponding to a higher risk of loss (“high-loss behaviors”) may be assigned a more negative rating, and may therefore be offered higher premiums for the same level of coverage.

Unfortunately, insurers generally have access to a very limited amount of information with respect to policy holder behaviors. Questionnaires provided by insurers to prospective policy holders are typically very limited in scope, as insurers may only be aware of a small subset of the universe of behaviors affecting the risk of loss. Moreover, responses to insurer questionnaires may in some cases be inaccurate. For example, a prospective policy holder may not know the precise number of alcoholic beverages, on average, that he or she imbibes per week. Further, companies providing certain types of insurance policies are at a particular disadvantage in this respect, as behaviors that substantially affect the likelihood of some types of losses are generally not well characterized, and may be difficult to assess based on questionnaires. For example, companies providing homeowners insurance may be unaware of many behaviors affecting the risk of losses within the home, and/or may find it difficult to determine whether a policy holder exhibits those behaviors. As a result, insurance ratings and premiums determined for the policy holder may be poorly correlated to the policy holder's risk of loss.

### BRIEF DESCRIPTION OF THE DRAWINGS

FIG. 1 is a block diagram of an example insurance rating system for determining an insurance premium based on in-home data.

FIG. 2 is a block diagram of an example insurance rating system showing example in-home data sources which may be utilized to determine an insurance premium.

FIG. 3 is a flow diagram of an example method for incentivizing low-loss behaviors.

FIG. 4 is a block diagram of an example insurance rating system for identifying correlations between in-home data and probabilities of incurring recognizable losses.

FIG. 5 is a flow diagram of an example method for identifying and incentivizing low-loss behaviors.

FIG. 6 illustrates a block diagram of an example computer system on which an example method for identifying and/or incentivizing low loss behaviors may operate in accordance with the described embodiments.

### DETAILED DESCRIPTION

The disclosed system collects data from one or more devices of a residence associated with a current or potential insurance policy holder, and analyzes the collected data (generally referred to herein as “in-home data”) in order to rate the policy holder for insurance purposes, such as determining the policy holder's insurance premium. As used herein, “residence” does not necessarily refer to a legal residence, and may include a real property that an individual owns, rents, leases, etc., but is not necessarily inhabited. The in-home data may be based on information generated by any of various devices found in home-centered systems, such as home automation and monitoring systems, and may be indicative of behaviors and/or conditions within the residence. For example, motion sensor, window sensor, and/or door sensor devices may generate data indicating times during which a residence is occupied, and home security system devices may indicate an occupant's habits with respect to arming the system. Once collected, the in-home data is analyzed to determine whether the in-home data is indicative of behaviors and/or conditions that are known to raise or lower the risk of a recognizable loss under the individual's insurance policy. For example, if it is known that certain usage patterns relating to home security systems (e.g., arming a system with at least a threshold frequency, arming a system at particular times of day, etc.) statistically correlate to a lower risk of in-home losses, then data generated by a home security device in the policy holder's home may be analyzed to determine whether any of those usage patterns exist. If the in-home data is determined to correspond to a behavior or condition known to lower the risk of loss, the policy holder's insurance premium may be lowered accordingly, for example.

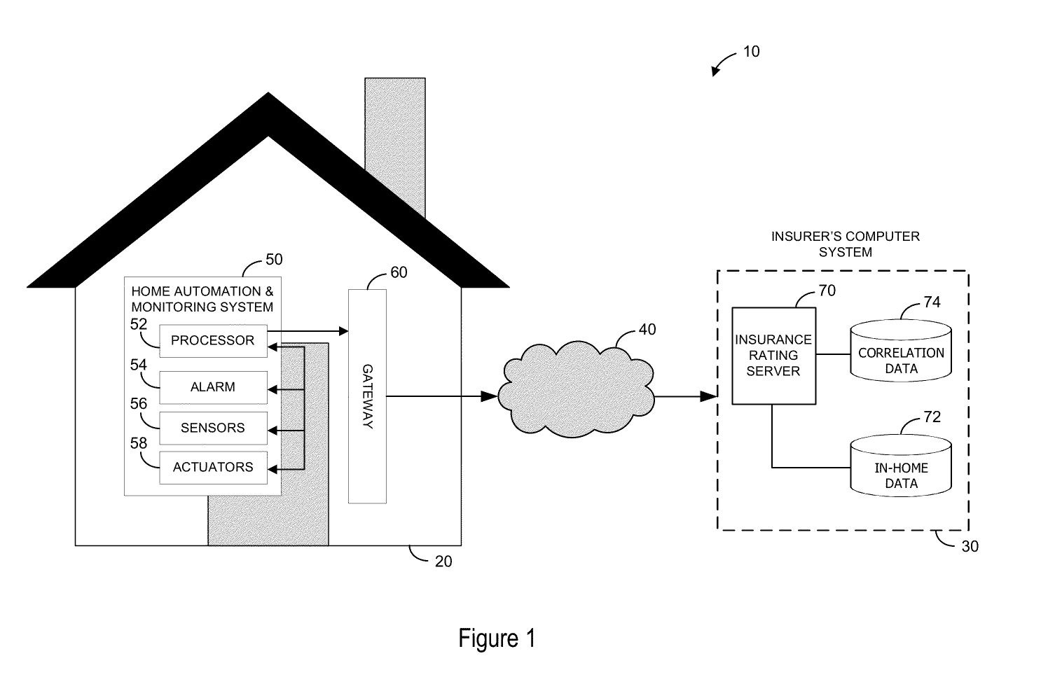

FIG. 1 is a block diagram of an example insurance rating system 10 for determining an insurance premium based on in-home data. The insurance rating system 10 includes a residence 20 (e.g., a single-family home, townhome, condominium, apartment, etc.) of an insurance policy holder. The insurance rating system 10 also includes an insurer's computer system 30, generally remote from the residence 20, which receives information from one or more devices in the policy holder's residence 20 via a network 40. The network 40 may be a single network, or may include multiple networks of one or more types (e.g., a public switched telephone network (PSTN), a cellular telephone network, a wireless local area network (WLAN), the Internet, etc.).

In the embodiment shown in FIG. 1, the policy holder's residence 20 includes a home automation and monitoring system 50 that includes a processor 52, an alarm 54, sensors 56, and actuators 58. The processor 52 accepts input from a human operator (e.g., from the policy holder) and controls the alarm 54, sensors 56, and actuators 58 accordingly. The operator may enter inputs to control the home automation and monitoring system 50 (e.g., setting light levels, setting an alarm, locking doors, setting a thermostat, etc.) by using a touch screen or analog control panel (not shown in FIG. 1) located at the residence 20, for example. Additionally or alternatively, the operator may control the home automation and monitoring system 50 by entering inputs in a smartphone, tablet, laptop computer, or other computing device, from either a remote location and/or while in the residence 20. The alarm 54 includes a device that generates an audio and/or visual alert when the processor 52 determines that certain programmed conditions have been satisfied, such as detecting motion with one or more of the sensors 56. Moreover, the processor 52 may support multiple alarm modes, each of which corresponds to a different set of conditions for triggering the alarm 54. For example, a first, “at home” mode (i.e., intended for times when the user or a guest is at the residence 20) may cause the processor 52 to trigger the alarm 54 only if a door or window is opened. Conversely, a second, “not at home” mode may likewise cause the processor 52 to trigger the alarm 54 if a door or window is opened, but also if motion is detected within the home. To determine whether conditions such as these are satisfied, the sensors 56 may include motion detectors, door sensors, window sensors, and/or other devices, with each device of the sensors 56 providing sensor data to the processor 52 indicating whether the respective condition (motion, door or window in an open position, etc.) has been sensed. In some embodiments, the processor 52 also sends control information to some or all of the sensors 56, in order to activate or deactivate the sensors 56. When the alarm 54 has been triggered, the processor 52 may cause an electronic message to be sent to a resident of the residence 20, a police department, and/or a home security service provider, for example.

The processor 52 also controls the actuators 58. The actuators 58 include devices (e.g., devices including switches/relays, motors, valves, etc.) for controlling various devices within the residence 20, such as light fixtures, fans, televisions, appliances, outlets, door locks, water shutoff valves, and/or automated blinds, for example. A memory (not shown in FIG. 1) coupled to the processor 52 may store the current state of some or all of the actuators 58. The current states may be based on past control signals sent from the processor 52 to the actuators 58, or may be based on state information sent from actuators 58 to the processor 52, for example.

In the embodiment shown in FIG. 1, the processor 52 of the home automation and monitoring system 50 is coupled to the network 40 via a gateway 60. The gateway 60 may be a network interface (e.g., a network interface card, chip set, etc.) of a device that also includes the processor 52, for example.

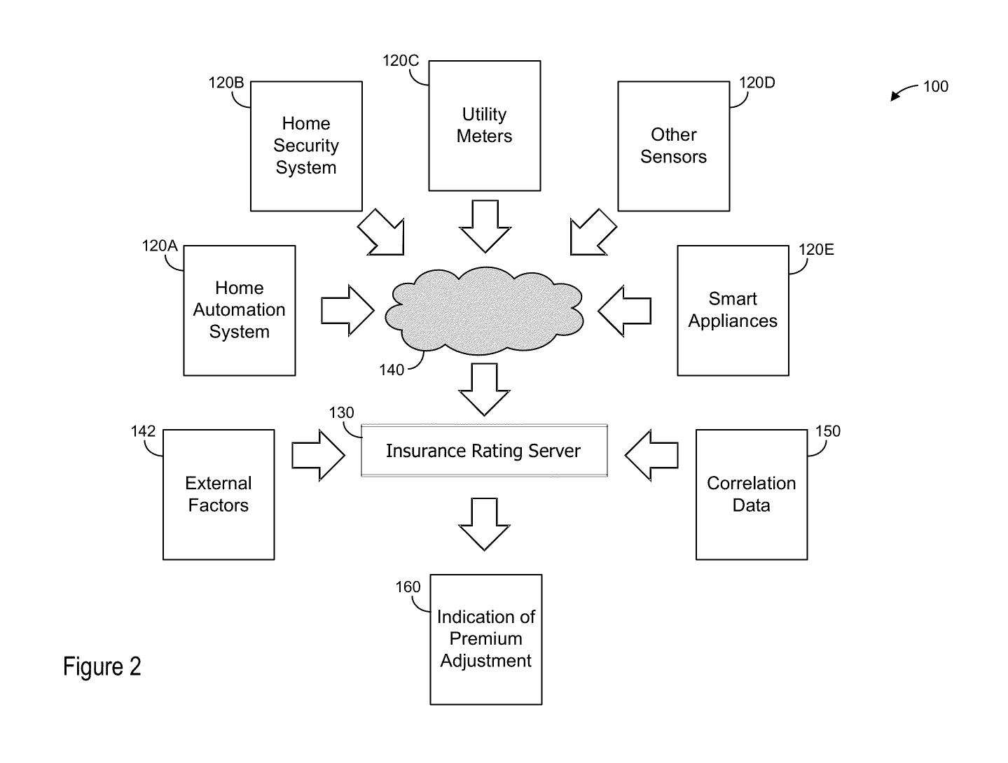

In other embodiments, different devices or systems are located at the residence 20, and/or the devices at the residence 20 are coupled to the network 40 in different ways than shown in FIG. 1. In one embodiment, for example, the home automation and monitoring system 50 includes more or fewer types of devices than are shown in FIG. 1. In an embodiment where the home automation and monitoring system 50 includes only home monitoring/security functionality, for example, the actuators 58 may not be included. Moreover, other devices, in addition to (or in place of) the home automation and monitoring system 50, may be located at the residence 20 and send data to the insurer's computer system 30 via the network 40 and/or the gateway 60. Examples of such devices are discussed below in connection with FIG. 2.

Further, in some embodiments, the gateway 60 is coupled to the network 40 via one or more in-home networks (not shown in FIG. 1), such as a WLAN, and/or the residence 20 includes one or more gateways in addition to the gateway 60. For example, a home security system may be coupled to a PSTN via a PSTN interface, while a home automation system that controls non-alarm systems may be coupled to the Internet via a WLAN interface card and an in-home WLAN, where both the PSTN and the Internet are included within the network 40 as parallel paths to the insurer's computer system 30.

Still further, in some embodiments, some or all of the in-home data associated with the residence 20 is sent to the insurer's computer system 30 via a third party, rather than directly from the residence 20. For example, a server of a home security system provider (not shown in FIG. 1) may collect usage data relating to the processor 52, alarm 54, and/or sensors 56, and send that information (or other data based on that information) to the insurer's computer system 30 via the network 40 or a different network.

Referring again now to the embodiment shown in FIG. 1, an insurance rating server 70 within the insurer's computer system 30 receives in-home data from the processor 52 via the gateway 60 and network 40. The insurance rating server 70 may be a single server, or a plurality of servers with distributed processing. The in-home data may be indicative of any of various kinds of usage, and/or any of various kinds of monitored/sensed conditions, relating to the processor 52, alarm 54, sensors 56, and/or actuators 58. For example, the in-home data may indicate times at which the processor 52 is set such that the security system is armed, alarm modes (“at home” mode, etc.), times at which the alarm 54 is triggered, times at which any of the sensors 56 detect particular conditions (e.g., open doors, open windows, motion, etc.), times and/or modes of operation of the actuators 58 (e.g., times when various lights are turned on, intensity settings of lights, etc.), and/or any other information relating to the operation of the home automation and monitoring system 50 at the residence 20.

The insurance rating server 70 stores the received in-home data in a memory 72, where the in-home data can be retrieved at a later time for processing. The insurance rating server 70 is also configured to retrieve correlation data stored in a memory 74. In other embodiments, the memory 72 and/or the memory 74 is/are instead located outside of the insurer's computer system 30, and is/are accessible by the insurance rating server 70 via a network such as the network 40. The correlation data stored in the memory 74 may include data modeling correlations between (a) usage patterns of in-home devices, and/or patterns relating to conditions monitored by in-home devices, and (b) likelihoods of incurring recognizable losses under the policy holder's policy. The insurance rating server 70 may be configured to analyze the in-home data stored in memory 72 using one or more of these correlation models in order to determine a risk rating, or a parameter corresponding to a risk rating (e.g., a change in an insurance premium). As an example in which a relatively simple correlation model is used, the insurance rating server 70 may compare the number of hours that the alarm 54 has been armed in a given month (as determined based on the in-home data received from processor 52) with one or more ranges of hours identified by the correlation data (e.g., 0-100 hours, 101-200 hours, etc.), and determine a risk indicator that the correlation data indicates as being associated with the range that matches the in-home data. To this end, the memory 74 may include a relational database, with each hour range corresponding to an indicator of a loss likelihood, for example. The insurance rating server 70 may then determine an insurance premium adjustment that corresponds to the identified risk indicator, such as a discount (5%, 10%, etc.) if a “low” risk has been identified. Alternatively, the insurance rating server 70 may determine a different benefit, such as an offer of a home security or home automation product, in order to reward the low-risk behavior of the policy holder without necessarily adjusting the policy holder's premium.

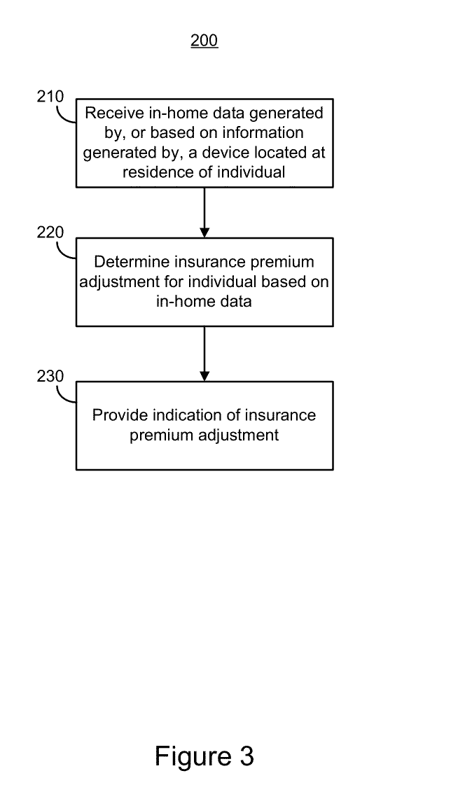

Alternatively, or additionally, the correlation data stored in the memory 74 may include more complex models or algorithms that depend on multiple types of data, generated by multiple in-home devices, in order to relate in-home data to risk of loss. Various example correlations are described below in connection with FIG. 3.

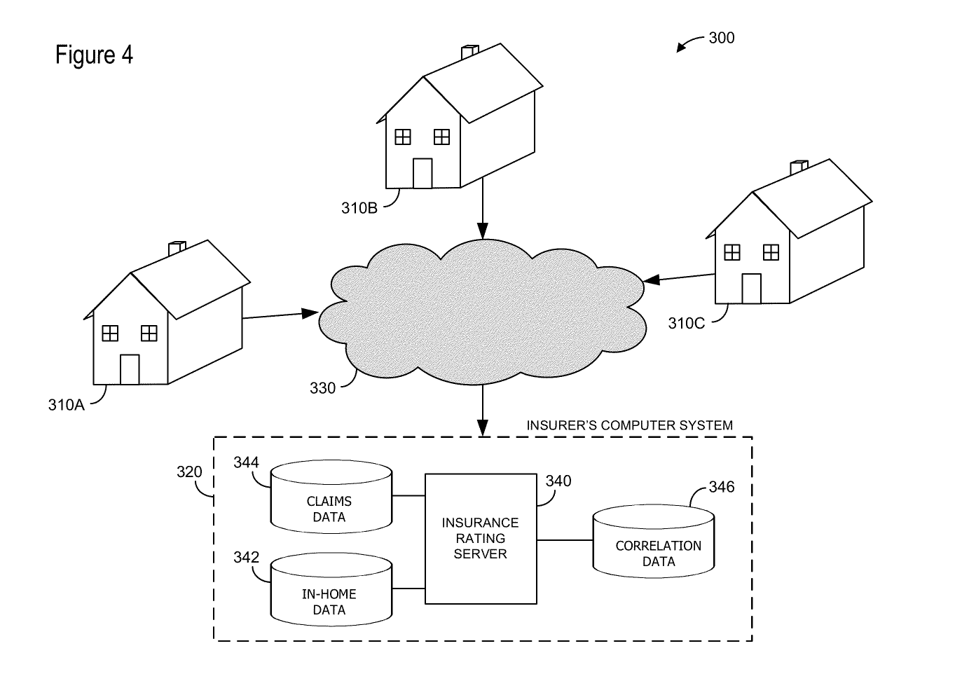

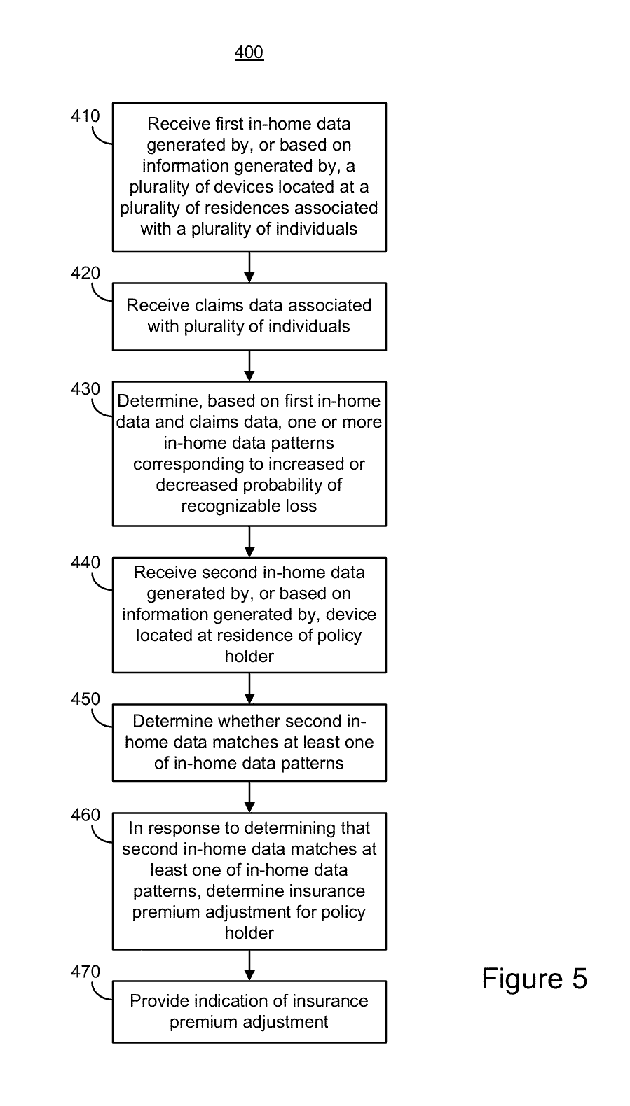

The correlation data stored in the memory 74 may be based on manually entered information, or may be “learned” by the insurance rating server 70 (or another server not shown in FIG. 1) based on the in-home data and claims data of a plurality of other policy holders, as described in more detail below in connection with FIGS. 4 and 5.

In some embodiments, the insurance rating server 70 checks whether the policy holder residing at the residence 20 has opted in to a discount/rewards program before utilizing his or her in-home data to determine an insurance rating. Alternatively, the devices within the residence 20 may not even be configured to communicate with the insurer's computer system 30 unless the policy holder has already opted in to the program, in which case the insurance rating server 70 may not need to determine whether the individual has opted in before utilizing the in-home data. In still other embodiments, the insurance rating system 100 utilizes in-home data of the policy holder without requiring the policy holder to opt in or agree to a specific program.

As noted above, information from various other types of in-home devices and systems may be utilized for insurance rating purposes. FIG. 2 is a block diagram of an example insurance rating system 100 showing a more extensive (but still non-exclusive) set of example in-home data sources 120A-120E which may be utilized to determine an insurance premium adjustment. Each of the in-home data sources 120A-120E provides data to an insurance rating server 130 over a network 140, which may itself comprise a plurality of networks. The network 140 may be similar to the network 40 of FIG. 1, for example.

Each of the in-home data sources 120A-120E in FIG. 2 represents one or more devices at a residence of a policy holder. For example, the home automation system data source 120A and home security system data source 120B may be parts of a single system similar to the home automation and monitoring system 50 of FIG. 1, including the devices associated with the processor 52, alarm 54, sensors 56, and/or actuators 58. The utility meters data source 120C may include utility meter devices, such as a water meter that includes a water volume sensor, a gas meter that includes a gas sensor, an electricity meter that includes an electricity sensor, etc. The “other sensors” data source 120D may include any of various other types of sensor devices, such as fire or smoke detectors, carbon monoxide detectors, thermostats, water detectors (e.g., to detect a water leak), door/window sensors, glass break sensors, temperature sensors, humidity sensors, door lock sensors, energy monitors, etc. The smart appliances data source 120E may include smart appliance devices that generate information relating to their usage, such as a smart refrigerator that indicates the temperature settings and how often the water filter is changed, a smart washing machine that generates repair/maintenance codes, or a smart light bulb, for example. Still other types of data sources, not shown in FIG. 2, may also provide information to the insurance rating server 130. For example, a camera in the home of a policy holder may provide video data which the insurance rating server 130 may process (without necessarily displaying the video) in order to detect movement and/or other behaviors and/or conditions (e.g., detecting smoke in the field of view of the camera). Not all data sources need be located in the interior of a residence, or in a living quarters portion of a residential property. For example, a tilt sensor that indicates whether a garage door is open, and/or an outdoor movement sensor or camera mounted on an exterior wall of a home, may provide data to the insurance rating server 130. Further, not all data sources need be permanent fixtures of the residence. For example, the data source 120D may include a smartphone with global positioning system (GPS) sensors that generates location data, which the insurance rating server 130 may use to determine whether the smartphone owner (e.g., the policy holder) is at home. In some embodiments, some or all of the data sources 120A-120E additionally provide information directly to the policy holder (e.g., alerts, warnings, current operational states, or other notifications), via a smartphone or other communication device.

The insurance rating server 130 may operate directly on the data provided by data sources 120A-120E, or may operate on other data that is generated based on the data from data sources 120A-120E. For example, the insurance rating server 130 may process the data from in-home data sources 120A-120E and convert it to a particular format (e.g., for efficient storage), and later utilize the modified data for insurance rating purposes.

In addition to receiving data from the in-home data sources 120A-120E over the network 140, the insurance rating server 130 receives data from an additional data source 142 coupled to the insurance rating server 130. The data source 142 provides information about external factors regarding the residence associated with in-home data sources 120A-120E (e.g., a home address, a crime rate associated with a geographic area that includes the residence, or other environmental factors), and/or the policy holder associated with the residence (age, gender, etc.), that influence or may influence the risk of loss under a policy. In other embodiments, the data source 142 is instead coupled to the network 140, and the insurance rating server 130 receives data from the data source 142 via the network 140. In still other embodiments, the insurance rating system 100 does not include the data source 142.

The insurance rating server 130 also receives data from a correlation data source 150 coupled to the insurance rating server 130. The insurance rating server 130 and correlation data source 150 may be similar to the insurance rating server 70 and memory 74 of FIG. 1, for example. In the example embodiment of FIG. 2, the insurance rating server 130 utilizes in-home data from one or more of the sources 120A-120E, as well as other data regarding the policy holder or policy holder's residence from the additional data source 142 (if present in the insurance rating system 100) and model data from the correlation data source 150, to determine an insurance rating of the policy holder associated with the in-home data sources 120A-120E. The determined insurance rating corresponds to the risk of loss associated with the monitored behaviors/conditions reflected by the in-home data.

Based on the determined insurance rating, the insurance rating server 130 generates an indication 160 of a premium adjustment (e.g., a premium discount in response to determining that the policy holder has a reduced risk of loss). In other embodiments, the insurance rating server 130 generates an indication of an incentive or reward other than a premium adjustment, such as a home security or automation device, a carbon monoxide detector, a smart appliance, etc. The indication may be information displayed to an operator of the insurer's computer system, data provided to a software module within the insurer's computer system, or a printable statement file which can be delivered to the policy holder, for example. The adjustment to the premium, and/or the total premium including the adjustment, may then be communicated to the policy holder.

The insurance rating system 100 of FIG. 2 may determine an insurance rating and/or premium adjustment in different ways according to numerous different embodiments and scenarios, using any of a wide variety of in-home data sources and any of a wide variety of correlation models. Some example embodiments are described here for illustration purposes.

In one example embodiment, the source 120B or the source 120D includes a tilt sensor detecting whether a garage door of the residence is open or closed, and the correlation data stored in the correlation data source 150 represents a correlation model under which a garage door that is more frequently left open (or left open at certain times of day or night, etc.) corresponds to a higher risk of loss. The insurance rating server 130 may therefore use data from the tilt sensor to determine a risk of loss and/or insurance premium adjustment according to the correlation model.

In another example embodiment, the source 120B includes one or more motion sensors, door sensors, and/or window sensors, and the correlation data stored in the correlation data source 150 represents a correlation model under which the percentage of time that a policy holder is home is inversely proportional to the policy holder's risk of a loss in the home (e.g., due to the individual being able to address any issues within the home, such as fire or water damage, as opposed to someone who is rarely home). For example, a vacation home or a vacant home may be at higher risk than a primary residence. The insurance rating server 130 may therefore use data from the motion sensors, door sensors, and/or window sensors to determine a risk of loss and/or insurance premium adjustment according to the correlation model.

In yet another example embodiment, the source 120C includes gas, water, and/or electricity meters that detect and indicate usage of the respective utilities, and the correlation data stored in the correlation data source 150 represents a correlation model under which a utility usage above a certain threshold (e.g., a determined average utility usage in the neighborhood of the policy holder's residence) corresponds to a higher risk of loss in the home. Alternatively (or additionally), the correlation data may represent a correlation model under which a very low electricity usage, which may indicate that the residence is not occupied, corresponds a higher risk of loss. The insurance rating server 130 may therefore use data from the utility meter(s) to determine a risk of loss and/or insurance premium adjustment according to the correlation model.

In still another example embodiment, devices of a home monitoring system (e.g., including the sources 120A and 120B) may generate information indicating the state or “health” of the system, such as whether the system is sufficiently powered (e.g., by batteries in the devices), kept online and connected, etc., and the correlation data stored in the correlation data source 150 represents a correlation model under which an “unhealthy” home monitoring system (e.g., one in which low batteries are not quickly replaced, etc.) corresponds to a higher risk of loss in the home. For example, a policy holder who is slow to replace batteries may also be less likely to practice other behaviors that tend to prevent losses, such as cleaning gutters, cleaning the lint out of a dryer vent, etc. The insurance rating server 130 may therefore use data from devices of the home monitoring system to determine a risk of loss and/or insurance premium adjustment according to the correlation model.

It is understood that the above examples are not exclusive, and that more than one such embodiment may coexist within a single insurance rating system.

FIG. 3 is a flow diagram of an example method 200 for incentivizing low-loss behaviors. The method 300 may be implemented by a computer, such as the insurance rating server 70 of FIG. 1, or the insurance rating server 130 of FIG. 2, for example.

The method 200 receives in-home data that is generated by, or based on information generated by, a device located at a residence of an individual (block 210). The residence may be a single-family home, townhome, condominium, or apartment, for example, and the individual may be a current policy holder or a potential policy holder (e.g., an individual to whom an insurance quote may be offered). The device generates in-home data indicative of a utilization of the device (e.g., data indicative of whether a security device is armed and the alarm mode, data indicative of usage of a light fixture or a smart appliance, etc.), and/or indicative of a condition monitored by the device (e.g., data indicative of sensed motion, data indicative of door or window positions, data indicative of the presence of smoke or carbon monoxide, data indicative of an amount of water, gas or electricity being used, etc.). For example, the in-home data may indicate one or more time periods during which the device was utilized, and/or during which the device detected a monitored condition. The device may be a device in the home automation and monitoring system 50 of FIG. 1, or any of the in-home data sources 120 of FIG. 2, for example.

The in-home data is received via a communication network, such as the network 40 of FIG. 1 or the network 140 of FIG. 2. In some embodiments, the in-home data is automatically received via the network, over a period of time, without any need for human involvement (e.g., entering requests for the information). Moreover, the in-home data may be data that was sent without any prompting, or may be data that was sent in response to one or more requests (e.g., from a server similar to insurance rating server 70 of FIG. 1 or insurance rating server 130 of FIG. 2) Further, in some embodiments, at least a portion of the in-home data is received via a third party (e.g., from a home security service provider that initially collects data from a home security system at the residence).

The method 200 also determines an insurance premium adjustment for the individual, based on the in-home data received at block 210 (block 220). The premium may be a monthly, quarterly, or annual premium, for example, and the premium may be for property/casualty insurance, homeowners insurance, or a different type of insurance. In some embodiments, the adjustment can be either a premium discount or “no change,” depending on the in-home data. In other embodiments, the adjustment can be either a discount or a premium penalty/increase. The premium adjustment may be determined for the individual's existing policy (if the individual is a current policy holder), or to be included in a quote (if the individual is a potential policy holder), for example.

In an embodiment, the method 200 determines the insurance premium adjustment based on the received in-home data at least in part by monitoring the in-home data to determine a behavior of one or more occupants of the residence, and determining the insurance premium adjustment based on the determined behavior. As a more specific example, in an embodiment in which the device is a motion sensor, a door sensor, or a window sensor, determining the insurance premium adjustment based on the received in-home data includes determining a pattern of occupancy associated with the residence of the individual (e.g., a percentage of time someone is at the residence, times of day when someone is detected at the residence, etc.), and determining the insurance premium adjustment based on the determined pattern of occupancy.

In an embodiment, the method 200 determines the insurance premium adjustment for the individual at least in part by determining an indication of loss likelihood based on (a) the received in-home data and (b) a known correlation between in-home data associated with one or more insurance policy holders and claims data associated with those insurance policy holders. One such embodiment is described in more detail below in connection with FIG. 4. Alternatively, the adjustment may be based on algorithms created based on human assumptions about how behaviors affect risk, or based on an analysis of claims data without analyzing any corresponding in-home data. For example, one might be justified in assuming that losses are more likely when an individual never arms a security system, and a review of past claims may indicate that losses are much more likely to occur when an individual leaves a garage door open.

The method 200 also provides an indication of the insurance premium adjustment determined at block 220 (block 230). The method 200 may provide the indication by displaying information to an operator of the insurer's computer system (e.g., insurer's computer system 30 of FIG. 1), data provided to a software module within the insurer's computer system (e.g., a software module that accepts various premium adjustments resulting from various determinations, and calculates a total premium), or a printable statement file which can be delivered to the individual as an account statement or quote, for example. The account statement or quote may show the adjustment to the premium, and/or the total premium including the adjustment, for example.

Blocks 210, 220 and 230 may be repeated multiple times. For example, in-home data may be received on a substantially continuous basis (e.g., at various times throughout each day, each week, etc.), and a new insurance premium adjustment may be determined on a periodic basis, or according to any other suitable schedule (e.g., whenever the received in-home data indicates that one or more particular, pre-established conditions have been satisfied). An indication of the new premium adjustment may then be provided each time a new premium adjustment is determined, for example.

In alternative embodiments, the method 200 may include additional blocks not shown in FIG. 3. For example, while the determined insurance premium adjustment (block 220) may itself be viewed as an insurance rating, or an indication of loss likelihood, the method 200 may determine a separate insurance rating or loss likelihood indication (e.g., “low,” “medium,” or “high” risk, or a number on a 1-100 scale, etc.), and then convert that metric to an insurance premium adjustment. As another example, the method 200 may additionally receive other in-home data that is generated by, or based on information generated by, a second device located at the residence of the individual. The additional in-home data may be indicative of a utilization of the second device, and/or a condition monitored by the second device, for example. In this embodiment, the method 200 may determine the insurance premium adjustment based not only on the in-home data received at block 210, but also based on the additional in-home data from the second device. In still other embodiments, more than two devices in the individual's residence provide in-home data that is used to determine the premium adjustment. As yet another example, the method 200 may include an additional block in which data corresponding to other, external factors (e.g., address of the residence, age of the individual associated with the residence, etc.) is received from a data source, such as data source 142 in FIG. 2. In this embodiment, the determination at block 220 may also be based on this additional data.

In yet another example, the method 200 may additionally determine whether the individual has opted into an incentives program. In this embodiment, the method 200 may receive the in-home data (block 210), and/or may determine the insurance premium adjustment based on that data (block 220), in response to determining that the individual has opted into the incentives program. In other embodiments, the method 200 does not determine whether the individual has opted into an incentives program.

In another alternative embodiment, the method 200 determines (block 220) and provides an indication of (block 230) an incentive, other than a premium adjustment, for practicing low-loss behaviors. For example, the method 200 may determine whether to reward the individual with a home automation or security product, and/or which type of product to offer, and provide an indication of any such product.

FIG. 4 is a block diagram of an example insurance rating system 300 for identifying correlations between in-home data and probabilities of incurring recognizable losses, which can then be used to determine an insurance rating. For example, the insurance rating system 300 may determine/generate the correlation data stored in the memory 74 of FIG. 1 or the correlation data source 150 of FIG. 2.

In the example insurance rating system 300, each of a plurality of residences 310A-310C sends in-home data to an insurer's computer system 320 via a network 330. Each of the residences 310A-310C (e.g., single-family homes, townhomes, condominiums, apartments, etc.) may be the residence of a different insurance policy holder, or, in some embodiments or scenarios, a single insurance policy holder may be associated with two or more of the residences 310. While three residences 310 are shown in FIG. 3, the insurance rating system 300 may include more or fewer residences in other embodiments and/or scenarios. For example, the residences 310 may include millions of residences associated with millions of policy holders.

Located at each of the residences 310A-310C are one or more devices capable of generating information relating to usage of those devices, and/or relating to conditions monitored by those devices. For example, each of the residences 310A-310C may include devices similar to the devices of the home automation and monitoring system 50 in FIG. 1, or similar to any of the in-home data sources 120A-120E in FIG. 2. The particular type(s) and number of devices at each of the residences 310A-310C may be identical, or may vary from one residence to the next.

The insurer's computer system 320 includes an insurance rating server 340 configured to receive in-home data from these devices via the network 330. To couple the various data-producing devices in the residences 310A-310C to the network 330, each of the residences 310A-310C may include one or more gateways similar to the gateway 60 of FIG. 1. The network 330 may include multiple sub-networks in series and/or in parallel (e.g., a different network coupling each of residences 310A-310C to the insurer's computer system 320, and/or different networks for different devices within a single residence, etc.). The network 330 may be similar to the network 40 of FIG. 1 or the network 140 of FIG. 2, for example.

The insurance rating server 340 collects the in-home data from the residences 310A-310C over time and stores the collected data in a memory 342. The insurance rating server 340 also has access to claims data of the policy holders associated with the residences 310A-310C, which is stored in a memory 344. The claims data indicates actual instances of past losses under the various insurance policies of the policy holders, along with associated information such as the date of the loss, the type of loss, any monies paid to the policy holders due to the loss, etc. The insurance rating server 340 may retrieve the claims data from the memory 344 and the collected in-home data from the memory 342, and utilize the retrieved data to identify particular patterns in the in-home data that exhibit strong correlations with contemporaneous losses identified in the claims data. For example, the insurance rating server 340 may determine that losses occur more frequently in residences that are occupied less often, with occupancy (e.g., as a percentage of time) being determined based on data from motion and/or door sensors. In other embodiments or scenarios, any of the correlations discussed above in connection with the examples provided for FIG. 1 or FIG. 2 (e.g., correlating data indicating a garage door is open with a higher risk of loss, etc.) may be determined by the insurance rating server 340.

The insurance rating server 340 may generate correlation models based on the identified patterns and correlations, which may then be used with the in-home data of an individual policy holder in order to determine an insurance rating for the policy holder (e.g., for adjusting a premium), as discussed above in connection with FIGS. 1 and 2. Generally, the correlation models may serve as a more reliable predictor of losses when in-home data is collected from a larger number of residences 310 and/or over a longer period of time. In an embodiment, however, in-home data is only collected from a particular residence if a policy holder associated with that residence has opted in to a program. For example, the insurance rating server 340 may only collect in-home data from the residences of those policy holders who have opted into a premium discount program using the disclosed insurance rating system. In an embodiment, all user-identifiable data is removed from the in-home data from each residence 310 (after matching the in-home data with the corresponding claims data) in order to preserve anonymity. In other embodiments, the insurance rating system 300 does not require policy holders to opt into a program before collecting and/or utilizing the policy holders' in-home data.

In an embodiment, the insurance rating system 300 is the same as the insurance rating system 10 of FIG. 1 or the insurance rating system 100 of FIG. 2. For example, the insurer's computer system 320 may be the same system as the insurer's computer system 30 of FIG. 1, the insurance rating server 340 of FIG. 3 may be the same server as the insurance rating server 70 of FIG. 1 or the insurance rating server 130 of FIG. 2, the in-home data memory 342 may be the same memory as the memory 72 of FIG. 1, and/or the correlation data memory 346 may be the same memory as the memory 74 of FIG. 1. Moreover, in some embodiments and scenarios, the residence of the policy holder for which an insurance rating is being determined (e.g., residence 20 of FIG. 1) is also one of residences 310. Thus, a first set of in-home data from a particular residence may initially be used (alone, or with the in-home data of other residences 310) to determine correlation models/data, and a later, second set of in-home data from the same residence may then be used along with the correlation models/data to determine an insurance rating for the policy holder associated with that residence.

FIG. 5 is a flow diagram of an example method 400 for identifying and incentivizing low-loss behaviors. The method 400 may be implemented by a computer, such as the insurance rating server 340 of FIG. 3, for example. Blocks 410, 420 and 430 generally relate to the process of collecting in-home data from the residences of multiple individuals, and using the collected in-home data in conjunction with the individuals' claims data to determine correlations between (a) in-home losses and (b) in-home behaviors and/or conditions. Blocks 440, 450, 460 and 470 generally relate to the process of collecting in-home data of a particular (current or potential) policy holder, and using the determined correlations in conjunction with the collected in-home data of the policy holder to determine a premium adjustment for the policy holder.

The method 400 receives first in-home data that is generated by, or based on information generated by, a plurality of devices located at a plurality of residences associated with a plurality of individuals (block 410). The first in-home data may include data indicative of utilizations of some or all of the plurality of devices, and/or data indicative of conditions monitored by some or all of the plurality of devices. The in-home data received from each residence may be similar to the in-home data received at block 210 of method 200 in FIG. 3, for example. The plurality of individuals may be current policy holders, potential policy holders, or a mix of both.

The first in-home data is received via one or more communication networks, such as the network 330 of FIG. 4. In some embodiments, the first in-home data is automatically received via the network(s), over a period of time, without any need for human involvement (e.g., entering requests for the information). Further, in some embodiments, at least a portion of the first in-home data is received via a third party (e.g., from a home security service provider that initially collects data from home security systems at the residences).

The method 400 also receives claims data associated with the plurality of individuals (block 420). The claims data may be retrieved from a memory such as the memory 344 of FIG. 4, for example. In an embodiment, the method 400 identifies which portion of the claims data corresponds to which portion of the first in-home data based on information in the first in-home data (e.g., IP addresses associated with a residence and therefore the policy holder, in an embodiment where the residence's in-home data is received via the Internet). To preserve anonymity, the method 400 may remove all user-identifiable data from the first in-home data after matching the portions of the first in-home data to the associated claims data.

The method 400 also determines, based on the first in-home data received at block 410 and the claims data received at block 420, one or more in-home data patterns corresponding to an increased or decreased probability of a loss recognizable under an insurance policy (block 430). The in-home data patterns may represent patterns of device usage, and/or patterns of sensed/monitored conditions, that can be matched to loss probabilities, and incorporated in a correlation model. For example, the method 400 may determine ranges of device output values that correspond to loss probabilities, scheduling/timing patterns that correspond to loss probabilities, etc.

The method 400 also receives second in-home data generated by, or based on information generated by, a device located at the residence of a current or potential insurance policy holder (block 440). While the first in-home data received at block 410 is used to determine in-home data patterns corresponding to various probabilities of losses in the home (i.e., correlation data), the second in-home data is used to assess the risk of loss associated with a particular (current or potential) policy holder. Block 440 may be similar to block 210 of the method 200 in FIG. 3, for example, and the second in-home data may be similar to the in-home data received at block 210 of the method 200.

The method 400 also determines whether the second in-home data received at block 440 matches at least one of the in-home data patterns determined at block 430. To this end, the second in-home data may be processed utilizing a correlation model generated based on the determined in-home data patterns. For example, in an embodiment in which the method 400 determines (at block 430) that one or more ranges of device output values correspond to an increased or decreased probability of incurring a recognizable loss, the method 400 may determine whether the second in-home data falls within at least one of those ranges of device output values. In other embodiments, the in-home data patterns are more complex, and determining whether the second in-home data matches any of the patterns involves more than simply determining a range within which a device output value falls. For example, the in-home data pattern(s) may reflect multiple parameters (e.g., state of a device or sensed condition, time of the state or condition, etc.), and/or the in-home data pattern(s) may be matched only by satisfying a non-trivial algorithm (e.g., only if a certain state or condition exists at certain times of day, or with a certain frequency, etc.).

The method 400 also, in response to determining at block 440 that the second in-home data matches at least one of the in-home data patterns, determines an insurance premium adjustment for the policy holder (block 460) (e.g., a premium adjustment that corresponds to the matched in-home data pattern(s)). The premium may be a monthly, quarterly, or annual premium, for example, and the premium may be for property/casualty insurance, homeowners insurance, or a different type of insurance. In some embodiments, the adjustment can be either a premium discount or “no change,” depending on the in-home data. In other embodiments, the adjustment can be either a discount or a premium penalty/increase. The premium adjustment may be determined for an existing policy (if for a current policy holder), or to include in a quote (if for a potential policy holder), for example.

The method 400 also provides an indication of the insurance premium adjustment (block 470). Block 470 may be similar to block 230 of FIG. 3, for example.

Blocks 410, 420 and 430, and/or blocks 440, 450, 460 and 470, may be repeated multiple times. For example, additional in-home data and claims data associated with the plurality of individuals may be received on a substantially continuous basis (e.g., at various times throughout each day, each week, etc.), and new in-home data patterns may be determined based on the additional in-home data on a continuous basis, a periodic basis, or according to any other suitable schedule. As another example, additional in-home data associated with the policy holder may be received on a substantially continuous basis, with new premium adjustments being determined for the policy holder based on comparisons between the additional in-home data of the policy holder and the original or updated in-home data patterns.

In alternative embodiments, the method 400 may include additional blocks not shown in FIG. 5. For example, while the determined insurance premium adjustment (block 460) may itself be viewed as an insurance rating, or an indication of loss likelihood, the method 400 determines a separate insurance rating or loss likelihood indication (e.g., “low,” “medium,” or “high” risk, or a number on a 1-100 scale, etc.), which is then converted to an insurance premium adjustment, in some embodiments. As another example, the method 400 additionally receives other in-home data that is generated by, or based on information generated by, one or more other devices located at the residence of the policy holder, and uses the additional in-home data (along with the second in-home data) when making the determination at block 450. As yet another example, the method 400 may include additional blocks in which data corresponding to other, external factors (e.g., home address, crime rates, or other data provided by a data source similar to data source 142 of FIG. 2) is also utilized. For example, data relating to external factors associated with the plurality of individuals may be received prior to block 430, and similar data may be received for the policy holder prior to block 450. In this embodiment, the method 400 may instead determine (at block 430) more complex data patterns that correspond to greater or lower loss probabilities, where the determined data patterns reflect correlations involving not only the first in-home data, but also the data pertaining to the external factors associated with the individuals. Also in this embodiment, the method 400 may use both the second in-home data and the data pertaining to external factors associated with the policy holder to determine (at block 450) whether a match exists with any of the data patterns determined at block 430.

In yet another example, the method 400 additionally determines whether the insurance policy holder has opted into an incentives program, in a manner similar to that described above in connection with FIG. 3, and/or determines that each individual of the plurality of individuals has opted into an incentives program before utilizing (or before collecting) the first in-home data. In other embodiments, the method 400 does not determine whether the policy holder has opted into an incentives program.

In another alternative embodiment, the method 400 determines (block 460) and provides an indication of (block 470) an incentive, other than a premium adjustment, for practicing low-loss behaviors. For example, the method 400 may determine whether to reward the policy holder with a home automation or security product, and/or which type of product to offer, and provide an indication of any such product.

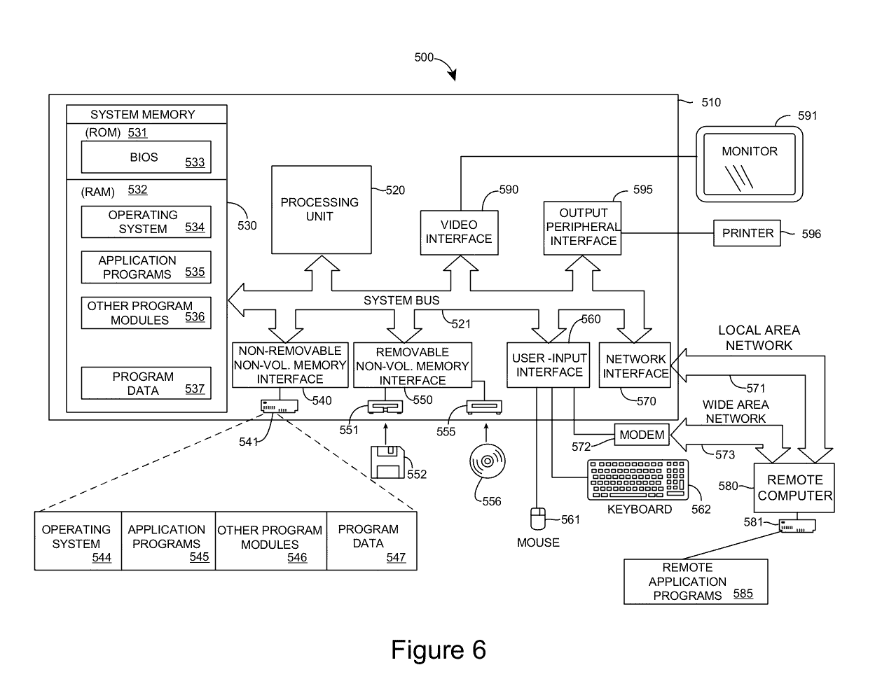

FIG. 6 illustrates a block diagram of an example computer system 500 on which an example method for identifying and incentivizing low loss behaviors may operate in accordance with the described embodiments. The computer system 500 of FIG. 6 includes a computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 510 typically includes a variety of computer readable media. Computer readable media can be any available media that can be accessed by computer 510 and includes both volatile and nonvolatile media, and both removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer readable media.

The system memory 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 6 illustrates operating system 534, application programs 535, other program modules 536, and program data 537.

The computer 510 may also include other removable/non-removable, volatile/nonvolatile computer storage media. By way of example only, FIG. 6 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 6 provide storage of computer readable instructions, data structures, program modules and other data for the computer 510. In FIG. 6, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and cursor control device 561, commonly referred to as a mouse, trackball or touch pad. A monitor 591 or other type of display device is also connected to the system bus 521 via an interface, such as a graphics controller 590. In addition to the monitor, computers may also include other peripheral output devices such as printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 6. The logical connections depicted in FIG. 6 include a local area network (LAN) 571 and a wide area network (WAN) 573, but may also include other networks. Such networking environments are commonplace in hospitals, offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the input interface 560, or other appropriate mechanism. In a networked environment, program modules depicted relative to the computer 510, or portions thereof, may be stored in the remote memory storage device 581. By way of example, and not limitation, FIG. 6 illustrates remote application programs 585 as residing on memory device 581.

The communications connections 570, 572 allow the device to communicate with other devices. The communications connections 570, 572 are an example of communication media, as discussed above.

The methods of the insurance rating system embodiments described above may be implemented in part or in their entirety using one or more computer systems such as the computer system 500 illustrated in FIG. 6. Referring generally to the embodiments of FIGS. 3 and 5, for example, in-home data, correlation data, and/or claims data may be received by a computer such as the computer 510. For example, in-home data may be received via a network interface similar to the network interface 570, which may in turn be coupled to a network similar to network 40 of FIG. 1, network 140 of FIG. 2, or network 330 of FIG. 4. As another example, the correlation data and/or claims data may be received from a remote source such as the remote computer 580 where the data is initially stored on memory device such as the memory storage device 581. As another example, the correlation data and/or claims data may be received from a removable memory source such as the nonvolatile magnetic disk 552 or the nonvolatile optical disk 556. As another example, the correlation data and/or claims data may be received as a result of a human entering data through an input device such as the keyboard 562.

Some or all calculations performed in the insurance rating system embodiments described above (e.g., calculations for determining an in-home data pattern, calculations for determining an insurance premium adjustment, etc.) may be performed by a computer such as the computer 510, and more specifically may be performed by a processor such as the processing unit 520, for example. In some embodiments, some calculations may be performed by a first computer such as the computer 510 while other calculations may be performed by one or more other computers such as the remote computer 580. The calculations may be performed according to instructions that are part of a program such as the application programs 535, the application programs 545 and/or the remote application programs 585, for example.

Indicating premium adjustments (or other incentives for practicing low loss behaviors), as described in the above embodiments, may also be performed by a computer such as the computer 510. The indications may be made by setting the value of a data field stored in the ROM memory 531 and/or the RAM memory 532, for example. In some embodiments, indicating premium adjustments or other incentives may include sending data over a network such as the local area network 571 or the wide area network 573 to another computer, such as the remote computer 581. In other embodiments, indicating premium adjustments or other incentives may include sending data over a video interface such as the video interface 590 to display information on an output device such as the monitor 591 or the printer 596, for example.

1. A computer-implemented method of incentivizing low-loss behaviors, the method comprising:
receiving, via a computer, in-home data that is generated by, or based on information generated by, a device located at a residence of an individual, wherein the in-home data is indicative of one or both of (i) a utilization of the device and (ii) a condition monitored by the device;
determining, via a computer and based on the received in-home data, an insurance premium adjustment for the individual; and
providing, via a computer, an indication of the determined insurance premium adjustment.

2. The computer-implemented method of claim 1, wherein receiving in-home data generated by, or based on information generated by, a device located at a residence of an individual includes receiving data indicative of user settings of one or both of (i) a home security system located at the residence, or (ii) a home automation system located at the residence.

3. The computer-implemented method of claim 1, wherein determining, based on the received in-home data, an insurance premium adjustment for the individual includes:
monitoring data from the device to determine a behavior of one or more occupants of the residence; and
determining the insurance premium adjustment based on the determined behavior.

4. The computer-implemented method of claim 1, wherein receiving in-home data generated by, or based on information generated by, a device located at a residence of an individual includes receiving in-home data generated by, or based on information generated by, a device that includes a sensor.

5. The computer-implemented method of claim 4, wherein receiving in-home data generated by, or based on information generated by, a device located at a residence of an individual includes receiving in-home data generated by, or based on information generated by, a device that includes a water volume sensor, an electricity sensor, a gas sensor, or a thermostat.

6. The computer-implemented method of claim 4, wherein receiving in-home data generated by, or based on information generated by, a device located at a residence of an individual includes receiving in-home data generated by, or based on information generated by, a device that includes a carbon monoxide detector or a smoke detector.

7. The computer-implemented method of claim 4, wherein receiving in-home data generated by, or based on information generated by, a device located at a residence of an individual includes receiving in-home data generated by, or based on information generated by, a device that includes a motion sensor, a door sensor, or a window sensor.

8. The computer-implemented method of claim 7, wherein determining, based on the received in-home data, an insurance premium adjustment for the individual includes:
determining a pattern of occupancy associated with the residence of the individual; and
determining the insurance premium adjustment based on the determined pattern of occupancy.

9. The computer-implemented method of claim 1, wherein receiving in-home data generated by, or based on information generated by, a device located at a residence of an individual includes receiving in-home data generated by, or based on information generated by, a smart appliance.

10. The computer-implemented method of claim 1, wherein the in-home data includes data indicating one or more time periods during which (i) the device was utilized or (ii) the monitored condition was detected.

11. The computer-implemented method of claim 1, wherein receiving in-home data generated by, or based on information generated by, a device located at a residence of an individual includes receiving in-home data generated by, or based on information generated by, a device located at a residence of a current insurance policy holder.

12. The computer-implemented method of claim 1, further comprising:
receiving additional in-home data generated by, or based on information generated by, an additional device located at the residence of the individual, wherein
the additional in-home data is indicative of one or both of (i) a utilization of the additional device and (ii) a condition monitored by the additional device, and
determining an insurance premium adjustment for the individual is further based on the received additional in-home data.

13. The computer-implemented method of claim 1, further comprising:
determining whether the individual has opted into an incentives program, wherein at least one of (i) receiving in-home data, or (ii) determining an insurance premium adjustment, is in response to determining that the individual has opted into the incentives program.

14. The computer-implemented method of claim 1, wherein receiving in-home data includes automatically receiving in-home data via a communication network.

15. The computer-implemented method of claim 1, wherein determining an insurance premium adjustment for the individual includes determining an indication of loss likelihood based on (i) the received in-home data, and (ii) a known correlation between in-home data associated with one or more insurance policy holders and claims data associated with the one or more insurance policy holders.

16. A non-transitory computer-readable storage medium comprising computer-readable instructions to be executed on one or more processors of a system for incentivizing low-loss behaviors, the instructions when executed causing the one or more processors to:
receive in-home data generated by, or based on information generated by, a device located at a residence of an individual, wherein the in-home data is indicative of one or both of (i) a utilization of the device and (ii) a condition monitored by the device;
determine, based on the received in-home data, an insurance premium adjustment for the individual; and
provide an indication of the determined insurance premium adjustment.

17. The non-transitory computer-readable storage medium of claim 16, wherein the instructions when executed cause the one or more processors to determine, based on the received in-home data, an insurance premium adjustment for the individual at least in part by:
monitoring data from the device to determine a behavior of one or more occupants of the residence; and
determining the insurance premium adjustment based on the determined behavior.

18. The non-transitory computer-readable storage medium of claim 17, wherein the instructions when executed cause the one or more processors to determine, based on the received in-home data, an insurance premium adjustment for the individual at least in part by:
monitoring data from the device to determine a pattern of occupancy associated with the residence of the individual; and
determining the insurance premium adjustment based on the determined pattern of occupancy.

19. The non-transitory computer-readable storage medium of claim 16, wherein the instructions when executed further cause the one or more processors to determine the insurance premium adjustment for the individual at least in part by determining an indication of loss likelihood based on (i) the received in-home data, and (ii) a known correlation between in-home data associated with one or more insurance policy holders and claims data associated with the one or more insurance policy holders.

20. A computer-implemented method of identifying and incentivizing low-loss behaviors, the method comprising:
receiving, via a computer, first in-home data generated by, or based on information generated by, a plurality of devices located at a plurality of residences associated with a plurality of individuals;
receiving, via a computer, claims data associated with the plurality of individuals;
determining, via a computer and based on the first in-home data and the claims data, one or more in-home data patterns corresponding to an increased or decreased probability of incurring a recognizable loss;
receiving, via a computer, second in-home data generated by, or based on information generated by, a device located at a residence of an insurance policy holder;
determining whether the received second in-home data matches at least one of the one or more determined in-home data patterns;
in response to determining that the received second in-home data matches at least one of the one or more determined in-home data patterns, determining an insurance premium adjustment for the insurance policy holder; and
providing an indication of the determined insurance premium adjustment.

21. The computer-implemented method of claim 20, wherein:
the first in-home data comprises data indicative of one or both of (i) utilizations of some or all of the plurality of devices located at the plurality of residences associated with the plurality of individuals and (ii) conditions monitored by some or all of the plurality of devices located at the plurality of residences associated with the plurality of individuals; and
the second in-home data comprises data indicative of one or both of (i) a utilization of the device located at the residence of the insurance policy holder and (ii) a condition monitored by the device located at the residence of the insurance policy holder.

22. The computer-implemented method of claim 20, wherein:
determining one or more in-home data patterns corresponding to an increased or decreased probability of incurring a recognizable loss includes determining one or more ranges of device output values; and
determining whether the received second in-home data matches at least one of the one or more determined in-home data patterns includes determining whether the received second in-home data falls within at least one of the one or more ranges of device output values.

23. The computer-implemented method of claim 20, further comprising:
determining whether the insurance policy holder has opted into an incentives program, wherein at least one of (i) receiving second in-home data, or (ii) determining an insurance premium adjustment, is in response to determining that the insurance policy holder has opted into the incentives program.

24. The computer-implemented method of claim 20, further comprising:
determining that each individual of the plurality of individuals has opted into an incentives program.
